(19) United States
(12) Patent Application Publication
(10) Pub. No.: US 2006/0206619 A1
(43) Pub. Date: Sep. 14, 2006

(54) Electronic service level agreement for Web site and computer services hosting

(75) Inventors: Asit Dan, Pleasantville, NY (US); Daniel M. Dias, Mohegan Lake, NY (US); Joseph L. Hellerstein, Ossining, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 11/434,096

(22) Filed: May 15, 2006

Related U.S. Application Data
(63) Continuation of application No. 09/642,526, filed on Aug. 18, 2000, now abandoned.

(51) Int. Cl. G06F 15/16

(52) U.S. Cl. 709/233

(57) ABSTRACT

Computer-based methods and systems are provided for building, provisioning and executing one or more electronic service level agreements (eSLAs) for Web and other computer hosting services, which specify and enforce service contracts for Web and other computer hosting services. In one aspect of the invention, a computer-based eSLA system includes four main components: (1) an eSLA builder; (2) an eSLA provisioner; (3) one or more execution systems; and (4) a system configuration and measurement system. Generally, the eSLA builder component provides the mechanism for defining and pricing the eSLA, checking the validity of the eSLA and a repository for storing the completed eSLAs. The provisioning system is responsible for configuring the run-time system in order to meet one or a set of eSLAs. The execution system is responsible for handling the run-time user requests, e.g., Web servers and load distributors, and a mechanism for enforcing the eSLAs at run-time. The system configuration and measurement system maintains information on the current system configuration, and run-time information on the metrics that are part of the eSLA.

### CROSS-REFERENCE TO RELATED APPLICATION(S)

This application is a continuation of U.S. application Ser. No. 09/642,526 filed on Aug. 18, 2000, the disclosure of which is incorporated herein by reference.

### FIELD OF THE INVENTION

The present invention relates generally to the global Internet network and, more particularly, to Internet servers of World Wide Web (WWW or Web) sites supporting one or more organizations hosted at these sites, and specifically providing service level agreements for each of these organizations.

### BACKGROUND OF THE INVENTION

The background of the present invention deals with how service applications are hosted at a third party infrastructure according to some Service Level Agreements (SLAs) for ensuring a certain level of end-client satisfaction. The Internet is the world's largest network, and it has become essential in organizations such as government, academia and commercial enterprises. Transactions over the Internet are becoming more common, especially in the commercial arena. Businesses increasingly run their applications using infrastructure (e.g., server, network connectivity) provided by a third party, referred to as the “service provider.”

Many companies, such as IBM Global Services, host Web sites, and/or provide other computer hosting services. While Web hosting will be used as the running example herein, those skilled in the art will readily appreciate that the invention applies to many other computer hosting services. Often, the clients to Web hosting services, are dissatisfied with the hosting service provided, because it does not meet their performance, availability, or functional expectations. A service contract or SLA provides a means by which the expectations of the service provider can be negotiated with the customer. Service contracts have existed for a decade or more. However, they have been paper agreements. Thus, it has been incumbent on the information technology (IT) staff to manually address the following: (a) what metrics must be measured; (b) what are the contractual implications of a service violation; and (c) what service levels can be met based on historical data. The source of this problem is that the SLA is not spelled out in an electronic form which can be monitored and violations of which can be flagged and penalized.

An SLA between an application owner and the service provider defines terms and conditions for this hosting service. The SLA may include expected bandwidth throughput at the network and/or servers, disk space utilization, availability, i.e., up-time of network and server resources, as well recovery time upon failure, and pricing for various levels of service.

For the most part, current SLAs are specified in textual form, e.g., D. McBride, “Toward Successful Deployment of IT Service Management in Distributed Enterprise,” CMG Proceedings, 1995; and “Why Frame Relay and What is an SLA?” at http://www.paradyne.com/framesaver-minisite/why-frame-relay.html. While there exists authoritative descriptions of how to translate textual SLAs into operational parameters, e.g., Leo Lo and Ken Kolence, “House of Quality and Service Management,” CMG Proceedings, 1994, in these cases, the SLA cannot be read by computers for the purpose of monitoring to detect violation of agreements, and/or used by a resource manager for automatic configuration/allocation of resources.

However, there has been recent work in which SLAs have been represented electronically and used to effect service levels. For example, in Jong-Tae Park et al., “Design and Implementation of Multi-domain Intranet Service Management System with QoS Support,” Journal of Electrical Engineering and Information Science, Vol. 4, No. 3, 1999, SLA contracts are described that specify parameters for the network, system, and application layers. A contract description language is employed and there is a mechanism for translating contracts into operational parameters.

In a U.S. patent application identified by U.S. Ser. No. 09/148,618, entitled: “Service Contract for Managing Service Systems,” and filed Sep. 4, 1998 in the name of Dan et. al., the disclosure of which is incorporated by reference herein, the concept of an electronic contract for capturing electronic interactions amongst a set of business servers is proposed. The electronic contract captures explicitly all aspects of the server-to-server interactions, including transport protocol(s), document format(s), security policies (signing, non-repudiation, encryption), business roles, associated actions, responsiveness, allowable sequences of messages and exception handling. Such an electronic contract enables businesses to reach agreements on the interaction process in spite of using heterogeneous platforms and software. This also enables them to hide their internal process while effectively interacting with their partners. Furthermore, such electronic contracts are used to enforce on-line allowable interactions. Finally, the contract can be used by any of the parties to automatically configure their internal software.

While existing art provides elements of electronic SLAs, key aspects are missing that are essential to obtain significant reductions in the cost of ownership for distributed environments, especially for service providers that provide computing to hosted applications. For example, absent in the existing art of electronic SLAs is an ability to check if the service level to be offered in a new contract is achievable given other contracts that have been committed. Further, while contracts are typically negotiated based on the service levels delivered for a price, existing systems do not consider pricing information. Lastly, when service levels are violated, there should be a process to renegotiate the service level agreement, if necessary. Such a process is not supported in existing art.

### SUMMARY OF THE INVENTION

The present invention provides computer-based methods and systems for building, provisioning and executing one or more electronic service level agreements (eSLAs) for Web and other computer hosting services, which specify and enforce service contracts for Web and other computer hosting services. Further, the present invention provides a process whereby an eSLA can be used for negotiation, service level monitoring, and enforcement.

In one aspect of the invention, a computer-based eSLA system includes four main components: (1) an eSLA builder; (2) an eSLA provisioner; (3) one or more execution systems; and (4) a system configuration and measurement system. Generally, the eSLA builder component provides the mechanism for defining and pricing the eSLA, checking the validity of the eSLA and a repository for storing the completed eSLAs. The provisioning system is responsible for configuring the (run-time) system in order to meet one or a set of eSLAs. The execution system is responsible for handling the run-time user requests, e.g., Web servers and load distributors, and a mechanism for enforcing the eSLAs at run-time. The system configuration and measurement system maintains information on the current system configuration, and run-time information on the metrics that are part of the eSLA.

In one preferred embodiment, the eSLA builder component has sub-components for authoring eSLAs, a pricer component for pricing the offered service, a validity checker for determining if the new eSLA along with existing eSLAs can be supported by the run-time system, and a repository for storing the eSLAs.

The eSLA authoring sub-component provides a mechanism for defining the elements for the service level agreement. For instance, an eSLA may identify the (principal) workload types. For example, for a storefront Web site, these could include: (i) Web browsing of the site; (ii) adding a browsed item to a shopping cart; and (iii) buying the set of items in the shopping cart. In general, the eSLA would have the minimum number of workload types that would provide adequate granularity for characterizing the load on the servers at a level needed by the service level agreement. The eSLA may then specify metrics used to characterize the service level agreed to. For a storefront Web site, the metrics could include: (a) the response time for requests of the workload types specified above, which could include further specifications of the average response time, 95th percentile of response time, or other metric of response time; (b) the maximum throughput for each workload type for which the response times are guaranteed, and preferably specification of whether the system will limit the throughput if it exceeds the stated maximum; (c) the maximum number of concurrent requests of each type in the system; (d) the system availability, either overall, or for each type of request. The number and the granularity of the metrics depends both on what metrics can be gathered, and on the smallest number of metrics that adequately characterize the performance or availability of the system.

The eSLA may also specify methodology for monitoring workload and service metrics (e.g., response time, availability). This may include both specification of data sensors and their placements in the execution path, as well as processing of data to generate desired metrics (e.g., weighted throughput, window for estimation of average, etc.).

The eSLA may also specify a set of conditions/rules that indicate a violation of the service agreement. Alternatively, this could be expressed as a negation of a set of conditions which completely specify when the agreement is met/satisfied. For example, for a Web site, the following conditions could be stated:

high_response: (weighted_response_time>r_max) & (weighted_throughput<t_max);

non_available: (continuous_down_time>cont_down_max)|(weekly_down_time>weekly_down_max).

More conditions, or conditions of finer granularity can be defined. In general, the minimum number of conditions that would indicate violation of the contract, at a level that can be measured, is defined.

The eSLA may also specify penalties associated with violation of the contract terms. Associated with each violation condition, a penalty clause is preferably defined. The penalty may be a function of the deviation from the agreed limits. The violation may occur either due to the actual workload exceeding specification or due to the failure in satisfying service metrics.

In one preferred embodiment, an overall computer-based eSLA methodology comprises the following steps:

(1) The eSLA, for example, with the above elements, is defined (preferably in a high level language using an authoring tool).

(2) After the eSLA is defined, it is then executed. This can be done by generation of code that executes the eSLA, or interprets the eSLA. Inputs to the eSLA executing step are measurements related to the defined metrics.

(3) Either on-line or off-line, violations of the eSLA are determined and output.

(4) For violations, penalties are computed.

(5) Preferably, alarms are generated if the eSLA is not violated but gets to within some threshold of violation. Warning of the amount of penalty that would be accrued if the violation were to occur may be indicated as a severity measure.

(6) Preferably, warnings are generated if the eSLA is not violated, or close to being violated, but a constraint, such as maximum allowable throughput according to the eSLA, is close to being violated.

(7) Based on violations, alarms, or warnings, the eSLA may be renegotiated, and a new eSLA defined, going back to step (2).

(8) Preferably, it may also be determined what eSLAs will be satisfied for a given workload based on historical data.

(9) Preferably, step (8) is used in conjunction with a workload forecasting and performance prediction tool to determine how long the eSLA will be satisfied.

(10) Preferably, logical inconsistencies in the eSLA are detected.

(11) Preferably, if the eSLA is linked to other service providers (e.g., a provider of Web hosting services that uses a provider of computing resources), then violations of service delivery by the subcontractor are linked to the ability of the main service provider to satisfy their eSLA.

(12) Preferably, an explanation is output as to why an eSLA violation occurred so that more complex eSLAs can be accommodated.

Many benefits result from the exploitation of the present invention. First, for example, service providers have automation whereby SLAs can be negotiated, provisioned, and enforced with feedback when violations occur. This capability enables new service offerings with service level guarantees.

Second, for example, pricing considerations can be incorporated into these negotiations. Often, customers ask for very high quality service without consideration for price. With eSLAs that consider pricing as well, negotiations can proceed much more rapidly.

Third, for example, the present invention provides a feedback mechanism whereby system administrators learn early on of failures to meet service level agreements thereby enabling new negotiations. Such failures result from many practical causes, including, for example: imperfections in the models of system performance, inaccuracies in workload forecasts, and scheduling changes in equipment acquisition.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an eSLA system according to an embodiment of the present invention and an overall environment in which such system may operate;

FIG. 2 is a block diagram illustrating components of an eSLA builder module according to an embodiment of the present invention;

FIG. 3 is a block diagram illustrating components of an eSLA provisioner module according to an embodiment of the present invention;

FIG. 4 is a block diagram illustrating components of an execution system according to an embodiment of the present invention;

FIG. 5 is a flow diagram illustrating an overall eSLA methodology according to an embodiment of the present invention;

FIG. 6 is a flow diagram illustrating an eSLA building process according to an embodiment of the present invention;

FIG. 7 is a flow diagram illustrating an eSLA provisioning process according to an embodiment of the present invention;

FIG. 8 is a flow diagram illustrating an eSLA execution process according to an embodiment of the present invention;

FIG. 9 is a flow diagram illustrating an eSLA violation reporting process according to an embodiment of the present invention; and

FIG. 10 is a block diagram illustrating a generalized hardware architecture of a computer system suitable for implementing an eSLA system according to the present invention.

### DETAILED DESCRIPTION OF PREFERRED EMBODIMENTS

The present invention will be explained below in the context of an illustrative Web site hosting services environment. That is, the parties to each eSLA are a Web application owner and a service provider (e.g., the party providing the infrastructure such as the server, network interconnectivity, etc.). However, it is to be understood that the present invention is not limited to such a particular environment. Rather, the invention is more generally applicable to any computer hosting services environment in which it is desirable to build, execute, monitor and act on electronic service level agreements in order to, among other things, obtain significant reductions in the cost of ownership and hosting associated with such environments.

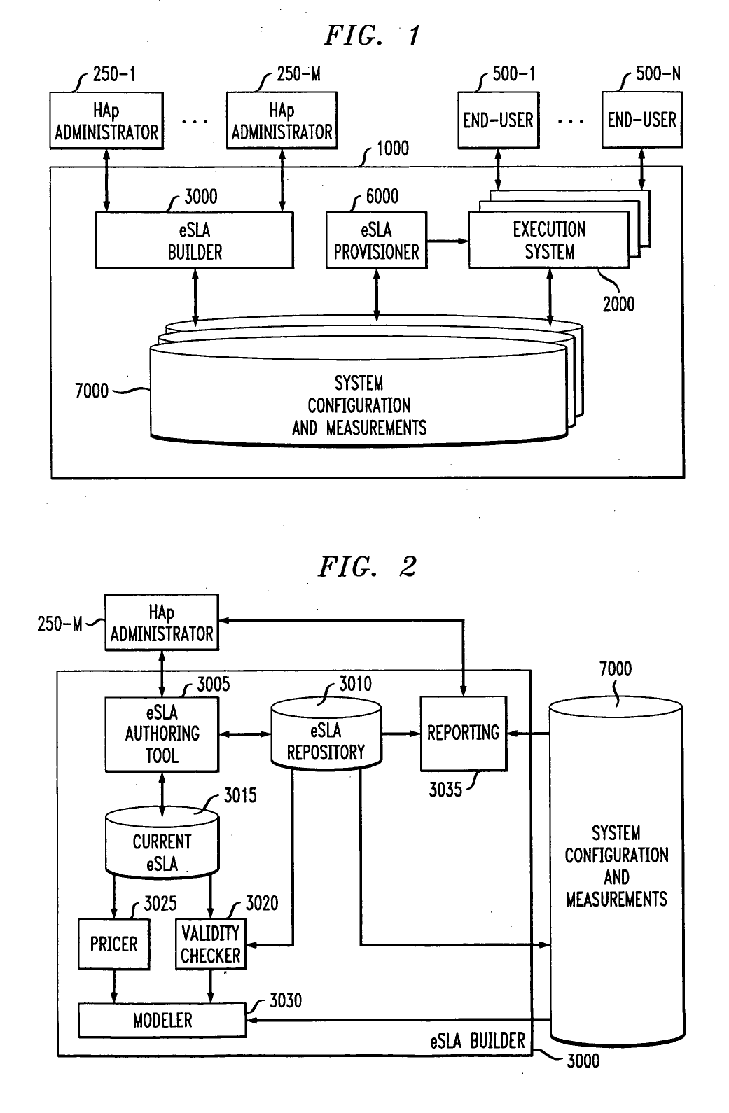

Referring initially to FIG. 1, a block diagram illustrates an eSLA system according to an embodiment of the present invention and an overall environment in which such system may operate. As shown, administrators of hosted applications via their respective computer systems 250-1 through 250-M and end-users via their respective computer systems 500-1 through 500-N communicate with the eSLA-based system 1000 of the present invention. The eSLA-based system is comprised of an execution system 2000 (more than one execution system may be employed depending on the number and nature of the eSLAs), an eSLA builder module 3000, an eSLA provisioner module 6000 and system configuration and measurements repositories 7000. The eSLA builder, eSLA provisioner and the execution system are operatively coupled to the system configuration and measurements repositories. The eSLA builder, eSLA provisioner and execution system may also be operatively coupled to each other.

In the Web hosting services embodiment, an administrator represents an owner of the application which is to be hosted on the third party infrastructure provided by the service provider. Once the application is hosted on the service provider's infrastructure in accordance with the terms and conditions of the eSLA agreed upon between the service provider and application owner, end-users may access the application via the Internet. The level of service received by the end-users when accessing the hosted application on the service provider's infrastructure is controlled and monitored by the execution system(s) provisioned in accordance with the one or more previously-built eSLAs.

More specifically, administrators and end-users interact with the eSLA-based system in the following manner. Administrators of hosted applications (250-1 through 250-M) communicate with the eSLA builder module 3000 to specify eSLAs for hosted applications and to receive reports of service level violations of the eSLAs. The eSLA provisioner 6000 translates the eSLAs into operational parameters, some of which are stored in the system configuration repositories 7000 and others of which are directly changed in the execution system 2000. That is, the provisioning system is responsible for configuring the run-time system in order to meet one or a set of eSLAs. End-users (500-1 through 500-N) interact with the execution system that operates in a manner specified by the eSLAs. Thus, the execution system is responsible for handling the run-time user requests, e.g., Web servers and load distributors, and a mechanism for enforcing the eSLAs at run-time. The repositories 7000 include one or more repositories for storing information on the current system configuration and run-time information on the metrics that are part of the eSLA. Each of these components and their operations will be described in greater detail below.

It is to be understood that, in this particular embodiment, each end-user and each administrator accesses the eSLA system via his/her own computer system. The components of the eSLA system may be implemented on one or more computer systems. The individual computer systems are preferably connected by one or more suitable networks such as, for example, the Internet. However, the present invention is not so limited. That is, it is possible that all participants and components shown in FIG. 1 access and/or reside on a single computer system. Of course, the eSLA system and its operating environment may be realized on any number of computer systems and, in a distributed environment like the Internet, will be realized on several computer systems coupled via a common communication network. An exemplary embodiment of one such computer system is described below in the context of FIG. 10.

Turning now to FIG. 2, a block diagram illustrates components of an eSLA builder module according to an embodiment of the present invention. As shown, the eSLA builder 3000 is comprised of an eSLA authoring tool 3005, an eSLA repository 3010, a current eSLA repository 3015, a validity checker module 3020, a pricer module 3025, a modeler module 3030 and a reporting module 3035.

The eSLA authoring tool 3005 interacts with administrators to construct a current eSLA which is stored in repository 3015. The eSLA authoring tool also retrieves and updates other eSLAs in the eSLA repository 3010, some of which may be for different hosted applications. In a preferred embodiment, XML (eXtensible Markup Language) is the authoring language and any suitable XML editor may serve as the authoring (and editing) tool.

After key information has been incorporated into an eSLA, it is checked for validity, including considerations for performance (e.g., can this eSLA be honored by the service provider given commitments made for other eSLAs). The validity checker 3020 provides this capability in cooperation with the modeler 3030 by determining if sufficient capacity is present.

Further, service pricing may be done as well. This is accomplished in accordance with the pricer module 3025. Automated pricing may, for example, be determined by contention-based pricing or by pricing based on response time targets. Service pricing may in part be based on resource consumption and priorities anticipated by the modeler to achieve service level objectives (e.g., response times). The system configuration and measurement component 7000 is updated when an eSLA is modified. Component 7000 exposes a subscription service whereby the provisioner module 6000 is notified when an update occurs. Similarly, the system configuration and measurement component provides a way for the reporting module 3035 to subscribe to events and measurement updates needed to provide operational information to administrators.

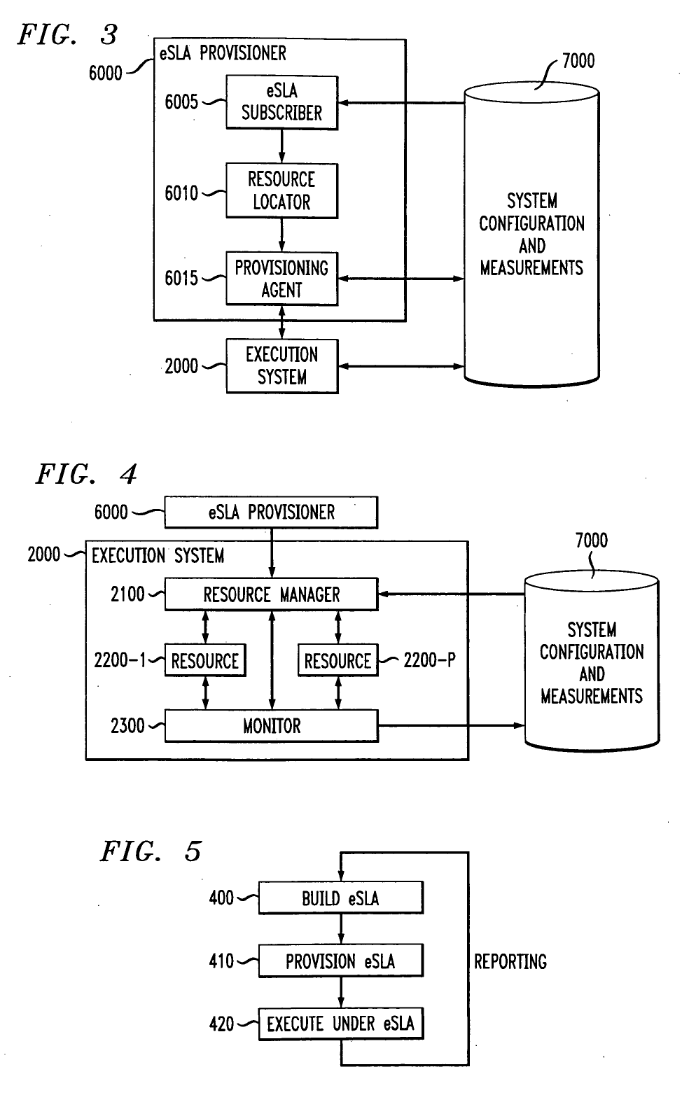

Referring now to FIG. 3, a block diagram illustrates components of an eSLA provisioner module according to an embodiment of the present invention. As shown, the eSLA provisioner 6000 is comprised of an eSLA subscriber module 6005, a resource locator module 6010 and a provisioning agent 6015. The eSLA subscriber 6005 subscribes to the creation of new eSLAs and changes in existing eSLAs in the system configuration and measurements repositories 7000. The resource locator 6010 identifies the resources affected by the eSLA. The provisioning agent 6015 updates, as required, the affected configuration parameters (of the repositories 7000) and the resource manager (of the execution system 2000, as will be explained below).

Referring now to FIG. 4, a block diagram illustrates components of an execution system according to an embodiment of the present invention. As mentioned above, the eSLA system 1000 may include more than one execution system depending on the number and nature of the eSLAs. In any case, as shown in FIG. 4, the execution system 2000 is comprised of a resource manager 2100 and a monitor module 2300. The resource manager 2100 provides overall control of resources 2200-1 through 2200-P in the execution system. Resources may, for example, include CPU, memory and network bandwidth. Part of this control is parameterized (e.g., scheduling priorities, memory allocations), which may be updated directly by a provisioning agent 6015 of the eSLA provisioner module 6000, or may be read from repositories 7000. The monitor 2300 provides metrics and events based on state changes in the resource manager and the resources. Examples include CPU utilization metrics and buffer overflow events.

It is to be appreciated that the one or more computer systems that embody the execution system(s) do not necessarily have to be the same computer systems and other infrastructure used to actually host the applications covered by the eSLAs. That is, the execution system may simply be one or more computer systems that control and monitor the equipment of the infrastructure used to host the applications.

Turning now to FIG. 5, a flow diagram illustrates an overall eSLA methodology according to an embodiment of the present invention. Administrators (250-1 through 250-M) build the eSLA in step 400 (via the eSLA builder 3000), which is then provisioned in step 410 (via the eSLA provisioner 6000) to one or more execution systems 2000 that then execute under the control specified by the eSLA in step 420. The effect of these eSLAs is then reported back to the builder 3000, which may cause the eSLA to be renegotiated if terms and/or conditions of the eSLAs cannot be met.

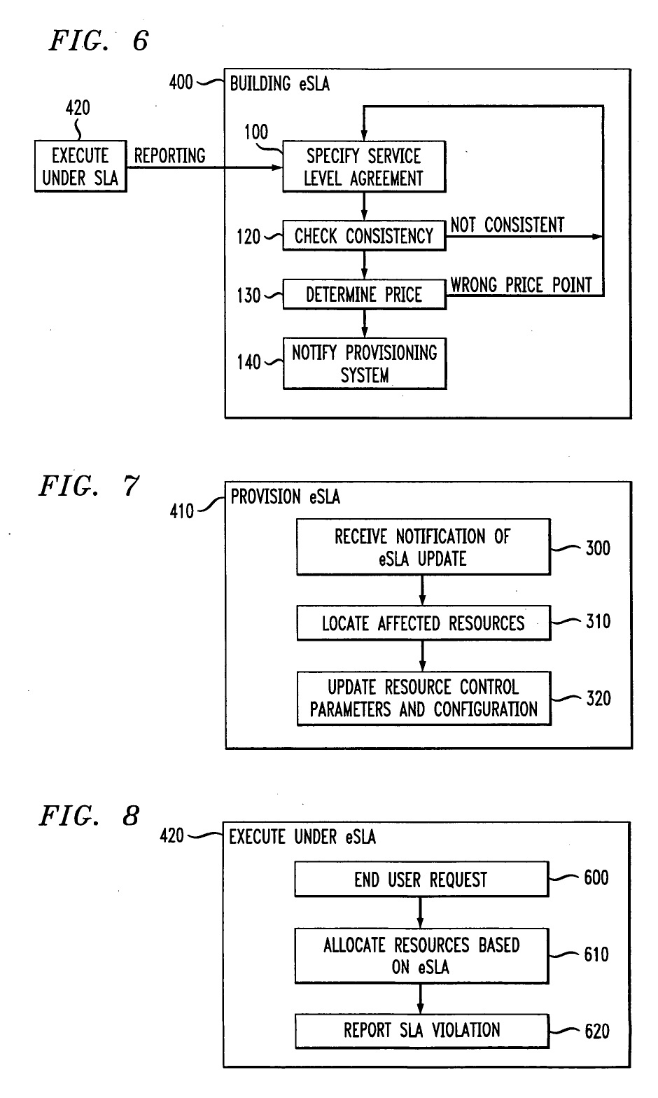

Referring now to FIG. 6, a flow diagram illustrates an eSLA building process according to an embodiment of the present invention. Specifically, FIG. 6 illustrates details of step 400 of FIG. 4. Accordingly, as shown in FIG. 6, an eSLA is specified through interactions with an administrator in step 100.

As described above, the eSLA authoring sub-component of the eSLA system provides a mechanism for defining the elements for the eSLA in accordance with an administrator. Through this automated mechanism, the eSLA is built. A preferred example of what an eSLA may specify is now given. An eSLA identifies the principal workload types. For example, for a storefront Web site, these could include: (i) Web browsing of the site; (ii) adding a browsed item to a shopping cart; and (iii) buying the set of items in the shopping cart. In general, the eSLA may have the minimum number of workload types that may provide adequate granularity for characterizing the load on the servers at a level needed by the eSLA. The eSLA may then specify metrics used to characterize the service level agreed to. For a storefront Web site, the metrics could include: (a) the response time for requests of the workload types specified above, which could include further specifications of the average response time, 95th percentile of response time, or other metric of response time; (b) the maximum throughput for each workload type for which the response times are guaranteed, and preferably specification of whether the system will limit the throughput if it exceeds the stated maximum; (c) the maximum number of concurrent requests of each type in the system; (d) the system availability, either overall, or for each type of request. The number and the granularity of the metrics depends both on what metrics can be gathered, and on the smallest number of metrics that adequately characterize the performance or availability of the system.

The eSLA may also specify methodology for monitoring workload and service metrics (e.g., response time, availability). This may include both specification of data sensors and their placements in the execution path, as well as processing of data to generate desired metrics (e.g., weighted throughput, window for estimation of average, etc.).

The eSLA may also specify a set of conditions/rules that indicate a violation of the service agreement. Alternatively, this could be expressed as a negation of a set of conditions which completely specify when the agreement is met/satisfied. For example, for a Web site, the following conditions could be stated:

high_response: (weighted_response_time>r_max) & (weighted_throughput<t_max);

non_available: (continuous_down_time>cont_down_max)|(weekly_down_time>weekly_down_max).

More conditions, or conditions of finer granularity can be defined. In general, the minimum number of conditions that would indicate violation of the contract, at a level that can be measured, are defined.

The eSLA may also specify penalties associated with violation of the contract terms. Associated with each violation condition, a penalty clause is defined. The penalty may be a function of the deviation from the agreed limits. The violation may occur either due to the actual workload exceeding specification or due to the failure in satisfying service metrics.

Of course, it is to be understood that the contents of the eSLA is highly dependent on the nature of the relationship between the parties to the agreement. Therefore, an eSLA specified in accordance with the invention may include any particular number and/or variety of clauses, conditions, remedies for violations, etc., constructed in accordance with the specific application for which it is being built.

Continuing reference to FIG. 6, in step 120, the eSLA is checked for consistency, especially with regard to capacity constraints given the other eSLAs that are committed to by the service provider. If some part of the eSLA is not consistent, the process returns to step 100. The noted inconsistencies may then rectified by the parties. Otherwise, in step 130, a price is determined for the services to be offered, as described previously for FIG. 2. If the price is not in agreement with the administrator's expectations, the process returns to step 100. Otherwise, the eSLA provisioner (6000 in FIG. 1) is notified of the new eSLA in step 140. It is to be appreciated that the eSLA building operation preferably receive reporting input from the execution system (shown as step 420 in FIG. 6).

FIG. 7 is a flow diagram illustrating an eSLA provisioning process according to an embodiment of the present invention. Specifically, FIG. 7 illustrates details of step 410 of FIG. 4. Accordingly, as shown in FIG. 7, an eSLA is either created for the first time or updated in step 300. In step 310, the affected resources are located. In step 320, resource control information is changed in the configuration repository (7000 in FIG. 1) and/or in the execution systems (2000 in FIG. 1) themselves.

Referring now to FIG. 8, a flow diagram illustrates an eSLA execution process according to an embodiment of the present invention. Specifically, FIG. 8 illustrates details of how the execution system performs step 420 of FIG. 4. Accordingly, as shown in FIG. 8, the execution system receives an end-user request in step 600. In step 610, the execution system allocates resources in the manner specified by the control parameters that have been set by the eSLA provisioner (6000 in FIG. 1). In step 620, SLA violations are reported.

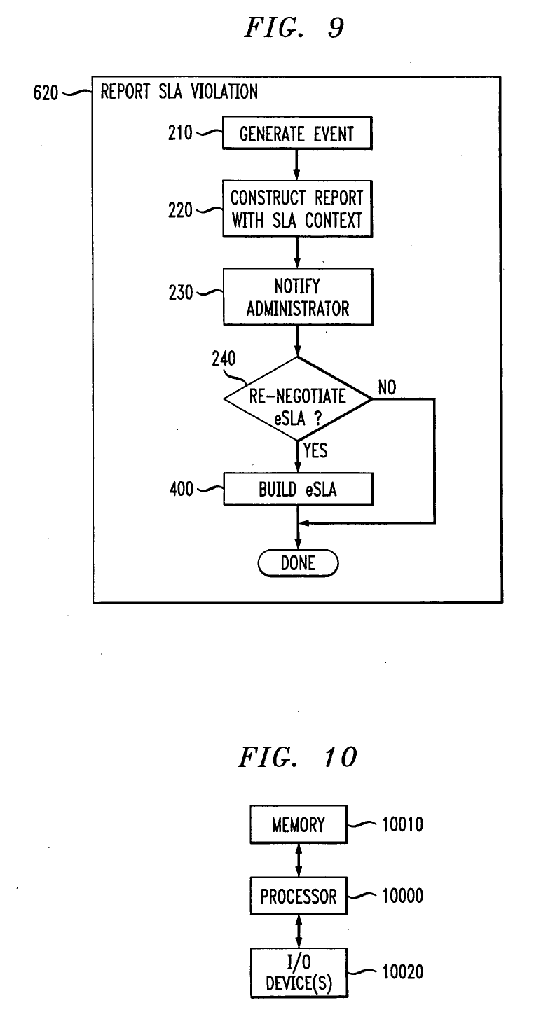

FIG. 9 is a flow diagram illustrating an eSLA violation reporting process according to an embodiment of the present invention. Specifically, FIG. 9 illustrates details of step 620 of FIG. 8. Accordingly, as shown in FIG. 9, the execution system generates an event in response to an occurrence associated with the hosted application. This event is stored in repository 7000 and is subscribed to by the eSLA builder 3000. In step 220, the reporting component (3035 of FIG. 2) constructs a report based on the event using the context provided by the eSLA for which the violation or near-violation, as explained below, occurred. In step 230, the appropriate administrator is notified. In step 240, the administrator decides whether to renegotiate the eSLA based on such feedback. If so, the eSLA building process is reentered.

It is to be appreciated that the determination and reporting of violations and near-violations may be accomplished either on-line or off-line. The system also may compute and report penalties associated with violations. Preferably, alarms are generated and reported if the eSLA is not violated but gets to within some threshold of violation. Warning of the amount of penalty that would be accrued if the violation were to occur may be indicated as a severity measure. Preferably, warnings are generated and reported if the eSLA is not violated, or close to being violated, but a constraint, such as maximum allowable throughput according to the eSLA, is close to being violated. Based on these violations, alarms, or warnings, the eSLA may be renegotiated, and a new eSLA defined.

Preferably, it may also be determined what eSLAs will be satsified for a given workload based on historical data. Further, such a determination is used in conjunction with a workload forecasting and performance prediction tool to determine how long the eSLA will be satisfied.

Further, if the eSLA is linked to other service providers (e.g., a provider of Web hosting services that uses a provider of computing resources), then violations of service delivery by the subcontractor are preferably linked to the ability of the main service provider to satisfy their eSLA.

Still further, an explanation is preferably output as to why an eSLA violation occurred so that more complex eSLAs can be accommodated.

Referring now to FIG. 10, a block diagram is shown illustrating a generalized hardware architecture of a computer system suitable for implementing one or more of the functional components/modules of an eSLA-based system as depicted in the figures and explained in detail herein.

As shown, the computer system may be implemented in accordance with a processor 10000, a memory 10010 and I/O devices 10020. It is to be appreciated that the term “processor” as used herein is intended to include any processing device, such as, for example, one that includes a CPU (central processing unit) and/or other processing circuitry. The term “memory” as used herein is intended to include memory associated with a processor or CPU, such as, for example, RAM, ROM, a fixed memory device (e.g., hard drive), a removable memory device (e.g., diskette), flash memory, etc. In addition, the term “input/output devices” or “I/O devices” as used herein is intended to include, for example, one or more input devices, e.g., keyboard, for entering data to the processing unit, and/or one or more output devices, e.g., CRT display and/or printer, for presenting results associated with the processing unit. It is also to be understood that the term “processor” may refer to more than one processing device and that various elements associated with a processing device may be shared by other processing devices.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. Apparatus for use in a computer hosting services environment, the apparatus comprising:
at least one processor operative to: (i) construct an electronic service level agreement between a service provider and a client based on client input for an application associated with the client to be hosted by the service provider; and (ii) check the consistency of the electronic service level agreement with respect to actual present resource requirements of one or more existing electronic service level agreements previously committed to by the service provider.

2. The apparatus of claim 1, wherein the at least one processor is further operative to modify the electronic service level agreement when at least one inconsistency is found.

3. The apparatus of claim 1, wherein the at least one processor is further operative to provision one or more resources of an infrastructure on which the application is to be hosted in accordance with the constructed electronic service level agreement.

4. The apparatus of claim 1, wherein the at least one processor is further operative to execute the constructed electronic service level agreement.

5. The apparatus of claim 1, wherein the at least one processor is further operative to report one or more events associated with the execution of the constructed electronic service level agreement.

6. The apparatus of claim 5, wherein the one or more events comprise at least one of a violation of a portion of the electronic service level agreement and a near-violation of a portion of the electronic service level agreement.

7. The apparatus of claim 5, wherein the at least one processor is further operative to provide a warning that a portion of the electronic service level agreement is one of violated and near-violated.

8. The apparatus of claim 5, wherein the at least one processor is further operative to provide an alarm that a portion of the electronic service level agreement is one of violated and near-violated.

9. The apparatus of claim 5, wherein the at least one processor is further operative to provide an explanation as to why a portion of the electronic service level agreement is one of violated and near-violated.

10. The apparatus of claim 1, wherein the at least one processor is further operative to determine whether the electronic service level agreement will be satisfied for a given workload based on historical data.

11. The apparatus of claim 10, wherein the at least one processor is further operative to determine for how long the electronic service level agreement will be satisfied based on a workload forecasting and performance prediction technique.

12. The apparatus of claim 1, wherein the constructing operation comprises determining pricing for inclusion in the electronic service level agreement associated with the hosting of the application by the service provider.

13. A computer-based method for use in a computer hosting services environment, the method comprising the steps of:
constructing an electronic service level agreement between a service provider and a client based on client input for an application associated with the client to be hosted by the service provider; and
checking the consistency of the electronic service level agreement with respect to actual present resource requirements of one or more existing electronic service level agreements previously committed to by the service provider.

14. The method of claim 13, further comprising the step of modifying the electronic service level agreement when at least one inconsistency is found.

15. The method of claim 13, further comprising the step of provisioning one or more resources of an infrastructure on which the application is to be hosted in accordance with the constructed electronic service level agreement.

16. The method of claim 13, further comprising the step of executing the constructed electronic service level agreement.

17. The method of claim 13, further comprising the step of reporting one or more events associated with the execution of the constructed electronic service level agreement.

18. The method of claim 17, wherein the one or more events comprise at least one of a violation of a portion of the electronic service level agreement and a near-violation of a portion of the electronic service level agreement.

19. The method of claim 17, further comprising the step of providing a warning that a portion of the electronic service level agreement is one of violated and near-violated.

20. The method of claim 17, further comprising the step of providing an alarm that a portion of the electronic service level agreement is one of violated and near-violated.

21. The method of claim 17, further comprising the step of providing explanation as to why a portion of the electronic service level agreement is one of violated and near-violated.

22. The method of claim 13, further comprising the step of determining whether the electronic service level agreement will be satisfied for a given workload based on historical data.

23. The method of claim 22, further comprising the step of determining for how long the electronic service level agreement will be satisfied based on a workload forecasting and performance prediction technique.

24. The method of claim 13, wherein the constructing step comprises determining pricing for inclusion in the electronic service level agreement associated with the hosting of the application by the service provider.

25. An article of manufacture for use in a computer hosting services environment, comprising a machine readable medium containing one or more programs which when executed implement the steps of:
constructing an electronic service level agreement between a service provider and a client based on client input for an application associated with the client to be hosted by the service provider; and
checking the consistency of the electronic service level agreement with respect to actual present resource requirements of one or more existing electronic service level agreements previously committed to by the service provider.

26. A computer-based system for use in a computer hosting services environment, the system comprising:
an electronic service level agreement building module which: (i) constructs an electronic service level agreement between a service provider and a client based on client input for an application associated with the client to be hosted by the service provider; (ii) checks the consistency of the electronic service level agreement with respect to actual present resource requirements of one or more existing electronic service level agreements previously committed to by the service provider; and (iii) modifies the electronic service level agreement when at least one inconsistency is found;
a provisioning module which provisions one or more resources of an infrastructure on which the application is to be hosted in accordance with the constructed electronic service level agreement; and
an execution system which executes the constructed electronic service level agreement in accordance with the one or more provisioned resources.
